(19) United States
(12) Patent Application Publication
(10) Pub. No.: US 2024/0198563 A1
(43) Pub. Date: Jun. 20, 2024

(54) METHOD AND DEVICE FOR PROCESSING PARTICLE FOAM MATERIAL TO PRODUCE A MOLDED PARTICLE FOAM PART

(71) Applicant: Siegfried Hofmann GmbH, Lichtenfels (DE)

(72) Inventors: Johannes SCHÜTZ, Lichtenfels (DE); Patrick FISCHER, Lichtenfels (DE); Thomas KLUGE, Lichtenfels (DE)

(21) Appl. No.: 18/556,377

(22) PCT Filed: Mar. 31, 2022
(86) PCT No.: PCT/EP2022/058544

§ 371 Date: Oct. 20, 2023

(30) Foreign Application Priority Data
Apr. 22, 2021 (DE) 102021110353.3

(51) Int. Cl. B29C 44/34; B29C 44/58; B29C 44/60; B29K 105/04

(52) U.S. Cl. CPC B29C 44/3426; B29C 44/58; B29C 44/60; B29K 2105/048

(57) ABSTRACT

A method for processing particle foam material for producing a particle foam molding includes generating a first process fluid flow which flows through a mold cavity defined by two mold elements, wherein the first process fluid flow flows into the mold cavity via at least one opening of a first mold element and flows out of the mold cavity via at least one opening of a second mold element. The method also includes generating a second process fluid flow, wherein the second process fluid flow flows into the second mold element via at least one opening of the second mold element and flows out of the second mold element via at least one opening of the second mold element, wherein the first and the second process fluid flow differ in at least one flow parameter that influences the flow properties.

The invention relates to a method and a device for processing particle foam material for producing a particle foam molding.

Methods and devices for producing particle foam moldings by processing expandable or expanded particle foam materials are known in principle in the prior art, in a plurality of different embodiments.

In this case, within the context of corresponding methods or the operation of corresponding devices, it is known to generate a process fluid flow which flows through a mold cavity defined by a plurality of mold elements and which flows into the mold cavity via at least one nozzle-like or nozzle-shaped opening of a first mold element, and flows out of the mold cavity via at least one nozzle-like or nozzle-shaped opening of a second mold element.

This principle, also referred to as cross evaporation, allows a process fluid, for example superheated steam, to flow through the mold cavity that is filled with the particle foam material that is to be processed to form a particle foam molding. In this case, the particle foam material, which is typically present in particulate form before the process fluid flows through the mold cavity, is bonded, by means of the energy input caused by the process fluid flow, and forms a particle foam molding.

Even if the principle leads essentially to satisfactory results in view of the particle foam moldings that can be produced thereby, there is a need for a development or improvement of the principle, for example in view of aspects such as the efficiency of the energy input or the introduction of energy within the context of the bonding process of respective particle foam materials to form particle foam moldings, and, associated therewith, the reduction of cycle times, etc.

The object of the invention is that of specifying an improved method for processing particle foam material for producing a particle foam molding. In an analogous manner, a correspondingly improved device for processing particle foam material for producing a particle foam molding is to be specified.

The object is achieved by the subjects of the independent claims. The claims dependent thereon relate to possible embodiments of the subjects of the independent claims.

A first aspect of the invention relates to a method for processing particle foam material for producing at least one particle foam molding. The method is accordingly directed to the processing of particle foam materials, i.e. expandable or expanded plastics particles (“plastics particles”) of at least one expandable or expanded plastics particle material (“plastics particle material”) for producing one or more particle foam moldings. According to the method, for example expandable or expanded plastics particles, e.g. based on polypropylene (PP or EPP), expanded and/or expandable polyamide (PA or EPA), expanded and/or expandable polystyrene (PS or EPS), and expanded and/or expandable thermoplastic elastomer (TPE), in particular expanded and/or expandable thermoplastic polyurethane (TPU), can be processed for producing a particle foam molding. Similarly, according to the method, particle foam materials based on what are known as biomaterials, i.e. expandable or expanded plant-based plastics particles, for example based on polysaccharide, i.e. for example based on starch or sugar, can be processed for producing a particle foam molding.

The method thus comprises, in general, carrying out one or more work processes for processing particle foam material for producing a particle foam molding. The term “work process” in principle includes any process that can be or is carried out within the context of the method, which is directly or indirectly related to the processing of a particle foam material for producing a particle foam molding.

Therefore, work processes which can be or are carried out according to the method are in particular processing processes in which (actual) processing of particle foam material filled into a mold cavity, i.e. in particular bonding of plastics particles to form a particle foam molding to be produced, takes place. Within the context of a processing process, typically at least one working or process fluid flow which flows through the mold cavity, filled with particle foam material to be processed to form a particle foam molding, is used. A working or process fluid that forms a respective working or process fluid flow can be an, in particular liquid, vaporous or gaseous, energy carrier fluid, i.e. for example a liquid, for example water, steam, for example superheated steam, or a gas, for example air, which transfers energy, i.e. in particular thermal energy, to the particle foam material, within the context of the processing process. As emerges in the following, the method relates in particular to a specific process control within the context of corresponding processing processes.

For the sake of completeness, it should be noted that work processes that can be or are carried out according to the method can equally be provision processes, in which a quantity of particle foam material to be processed, in particular a quantity of particle foam material to be processed in a processing process, is provided, conveying processes, in which a quantity of particle foam material, in particular a quantity of particle foam material to be processed in a processing process, is conveyed along a conveying path in the direction of a mold cavity, or filling processes, in which a quantity of particle foam material, in particular a quantity of particle foam material to be processed in a processing process, is filled into a mold cavity.

In order to carry out respective work processes, a device used for carrying out the method comprises one or more functional units. Examples for corresponding functional units are cited below, in connection with a device according to the second aspect of the invention.

The essential steps of the method are explained in more detail in the following:

The method includes a first step of generating a first process fluid flow, i.e. for example a flow of steam or superheated steam, which flows through a mold cavity defined by two mold elements of a mold. The first process fluid flow flows into the mold cavity via at least one opening of a first mold element of the mold—as becomes clear in the following, this is typically an, in particular nozzle-like or nozzle-shaped, third opening of the first mold element—and flows out of the mold cavity via at least one opening of a second mold element of the mold—as becomes clear in the following, this is typically an, in particular nozzle-like or nozzle-shaped, third opening of the second mold element. Therefore, in the first step of the method, what is known as cross evaporation of the (in this case typically virtually or completely closed) mold cavity typically takes place, i.e. the first process fluid flow flows into the first mold element via respective first openings of the first mold element, flows out of the first mold element and into the mold cavity via respective third openings of the first mold element, flows through the mold cavity in the direction of the second mold element, wherein bonding of the particle foam material located in the mold cavity, forming the particle foam molding to be produced, takes place, flows into the second mold element via respective third openings of the second mold element, and flows out of the second mold element via respective second openings of the second mold element.

Similarly, the method includes a second step of generating a second process fluid flow, i.e. for example a flow of steam or superheated steam. The second process fluid flow flows into the second mold element via at least one first opening of the second mold element, and flows out of the second mold element via at least one second opening of the second mold element. Therefore, in the second step of the method, in parallel with the cross evaporation taking place in the first step of the method, a second process fluid flow that flows through the second mold element between a respective first and second opening is generated, such that during the cross evaporation additional energy can be introduced into the second mold element, in a purposeful manner, via the second process fluid flow. The second step of the method is typically not a second cross evaporation of the mold cavity proceeding from the second mold element, as the second process fluid flow typically flows through the second mold element only between respective first and second openings of the second mold element, but does not flow out into the mold cavity via corresponding, in particular nozzle-like or nozzle-shaped, third openings of the second mold element.

As emerges in the following, according to the method the first and the second step are typically carried out simultaneously. The designation “first step” and “second step” therefore does not indicate that the steps are carried out in a temporally successive manner, but rather that these are respective steps of generating corresponding first and second process fluid flows.

According to the method, the first and the second process fluid flow differ in at least one flow parameter that influences the flow properties. The setting, i.e. in particular control or regulation, of respective flow parameters that influence the flow properties of the first and second process fluid flow, which is possible, in a purposeful manner, according to the method, via a corresponding control and/or regulating device, is thus carried out with the proviso that the first and the second process fluid flow differ with respect to at least one flow parameter that influences the flow properties. This purposeful adjustment of the flow parameters or properties of the process fluid flows to one another makes it possible to ensure that the first and second process fluid flows do not compromise one another. Said purposeful adjustment of the flow parameters or properties of the process fluid flows to one another in particular makes it possible to ensure that the second process fluid flow does not negatively influence the first process fluid flow, flowing through the mold cavity, and thus the bonding of the particle foam material, occurring or brought about by means of the first process fluid flow, for producing a respective particle foam molding.

The method is thus based on the principle of the generation of a corresponding second process fluid flow, which takes place additionally to the generation of a corresponding first process fluid flow, which surprisingly has a very positive effect on the efficiency of the processing process and thus on the efficiency of the method as a whole, as the energy additionally supplied to the second mold element by the second process fluid flow increases the efficiency of the energy input or the introduction of energy within the context of the bonding process of respective particle foam materials to form particle foam moldings, and, associated therewith, allows for a cycle times to be reduced.

Thus, overall, an improved method for processing particle foam material for producing a particle foam molding is provided.

The at least one flow parameter influencing the flow properties can in particular be the pressure or the pressure level of the first and second process fluid flows. Therefore, the control or regulation of respective flow parameters that influence the flow properties of the first and second process fluid flow, which is possible, in a purposeful manner, according to the method, via a corresponding control and/or regulating device, can thus be carried out with the proviso that the first and the second process fluid flow differ with respect to their pressure or pressure level. The acquisition of the pressure or pressure level of the respective process fluid flows can be carried out by means of pressure acquisition devices, such as pressure sensors. Corresponding pressure acquisition devices can be arranged or formed for example on or in respective mold elements. In particular, corresponding pressure acquisition devices can be arranged or formed on or in the region of respective first and/or second and/or third openings of the respective mold elements. The pressure or pressure level of respective process fluid flows can thus relate, for example, to the pressure or the pressure level during inflow and/or outflow of the respective process fluid flows into or out of the respective mold elements.

According to the method, the second process fluid flow typically has a lower pressure than the first process fluid flow. In this way, it is possible to ensure that the second process fluid flow does not impair the first process fluid flow, for example in that the second process fluid flow impedes, on account of too high a pressure, an outflow of the first process fluid flow out of the mold cavity via corresponding third openings of the second mold element, or an inflow of the first process fluid flow into the second mold element via respective third openings of the second mold element. The pressure or the pressure level of the second process fluid flow can be selected, in particular relative to the pressure or pressure level of the first process fluid flow, in particular after this has flowed through the mold cavity, in such a way that a certain suction effect is generated by the second process fluid flow, which promotes the flow of the first process fluid flow through the mold cavity.

On the basis of studies, it was possible to demonstrate that the second process fluid flow expediently has a pressure that is lower than that of the first process fluid flow by a factor of 2. However, this is to be understood as being by way of example. The pressure or the pressure level of the second process fluid flow can be for example 0.95 times, 0.9 times, 0.85 times, 0.8 times, 0.75 times, 0.7 times, 0.65 times, 0.6 times, 0.55 times, 0.5 times, 0.45 times, 0.4 times, 0.35 times, 0.3 times, 0.25 times, 0.2 times, 0.15 times, 0.1 times, or 0.05 times the pressure or pressure level of the first process fluid flow.

At this point it should be noted, in a general manner, that the corresponding pressure differences between the first and the second process fluid flow can, according to the method, optionally be adjusted or set, i.e. in particular controlled or regulated, dynamically, in a positive or negative manner, i.e. upwards and/or downwards. For example, the pressure or the pressure level of the second process fluid flow can be, at a first timepoint, for example 0.75 times, and at a further timepoint 0.9 times or 0.4 times the pressure or pressure level of the first process fluid flow. In principle, the implementation of different, optionally variable, pressure difference profiles is thus conceivable, which profiles are typically selected depending on properties of the particle foam material to be processed, such as the chemical and/or physical composition of the particle foam material, and/or of properties of the configuration of the mold, such as the size of the mold cavity, etc.

It follows, from the above explanations regarding the generation of corresponding first and second process fluid flows, that the or a device used for carrying out the method thus comprises a mold comprising at least two mold elements, which can optionally also be referred to as mold halves, which are configured to define a mold cavity, which can optionally also be referred to as a process chamber. The respective mold elements each comprise at least one first opening, which can optionally also be referred to as an inflow opening and via which a process fluid or a process fluid flow can flow into the respective mold element, and at least one second opening, which can optionally also be referred to as an outflow opening and via which a process fluid or a process fluid flow can flow out of the respective mold element. The respective mold elements furthermore comprise at least one third opening, which is in particular formed in the manner or shape of a nozzle and via which a process fluid flow which has flowed into the respective mold element via at least one first opening can flow out of the respective mold element into the or a mold cavity.

The respective first, second and third openings of a respective mold element are typically fluidically interconnected via a flow channel structure that comprises at least one flow channel that passes through the respective mold element, at least in portions, such that a process fluid flow that has flowed into a respective mold element via a respective first opening can flow out of the respective mold element via a respective second opening and/or via a respective third opening. A corresponding flow channel structure can in each case extend at least in portions close to the contour, i.e. closely under respective shaping mold element portions of respective mold elements, for example in order to enable an energy transfer from the respective mold element portion to the or a particle foam material filled into the mold cavity, when a process fluid flow flows through.

In particular, respective first and second openings on the mold element side can each be assigned at least one closure device, which comprises at least one closure element that is movable between a first position, which can also be referred to as the open position and in which a process fluid flow can flow through the respective closure device, and a second position, which can also be referred to as the closed position and in which a process fluid flow cannot flow through the respective closure device. A corresponding closure element can typically also be moved into at least one intermediate position located between a corresponding first and second position.

Corresponding closure devices can in particular be configured as or comprise active or passive flow limiters. Corresponding active or passive flow limiters can be configured for example as valve devices, in particular as controllable or regulatable control valve devices. In order to carry out the method, in particular controllable or regulatable control valve devices are possible or are used.

According to the method, in order in order to process particle foam material for producing a particle foam molding, a first and a second mold element can thus be used, which each comprise a flow channel structure which is arranged or formed so as to extend between at least one respective first opening, which can be referred to as the inflow opening, and at least one respective second opening, which can be referred to as the outflow opening, and through which flow channel structure the first and/or second process fluid flow can flow or flows. As mentioned, the respective first opening(s) can be assigned at least one first valve or control valve device, in general a corresponding closure device, and/or the respective second opening(s) can be assigned at least one second valve or control valve device, in general a corresponding closure device.

The generation, carried out according to the method, of a corresponding first process fluid flow, the first process fluid flow flowing into the mold cavity via at least one third opening of a first mold element and, after flowing through the mold cavity, flowing out of the mold cavity via at least one third opening of a second mold element thus typically includes, for a device configured accordingly, with respect to the respective first mold element, the at least one first opening of the first mold element being released for inflow of the first process fluid flow into the first mold element via the at least one first opening; therefore, the closure element of a closure device assigned to the at least one first opening of the first mold element is moved into the open position. In the same way, the at least one second opening of the first mold element is not released for outflow of the first process fluid flow out of the first mold element via the at least one second opening; therefore, the closure element of a closure device assigned to the at least one second opening of the first mold element is moved into the closed position. Thus, the first process fluid flow, which has flowed into the first mold element via the at least one first opening, flows out of the first mold element, via the at least one third opening of the first mold element, into the mold cavity that is typically filled with particle foam material. After the first process fluid flow has flowed through the mold cavity, which, as mentioned, is typically filled with particle foam material, the first process fluid flow flows into the second mold element via at least one third opening of the second mold element, and flows out of the second mold element via at least one second opening of the second mold element.

The generation, carried out according to the method, of a first process fluid flow that flows through a mold cavity defined by two mold elements, the first process fluid flow flowing into the mold cavity via at least one third opening of a first mold element and flowing out of the mold cavity via at least one second opening of a second mold element, thus typically includes, for a device configured accordingly, with respect to the respective second mold element, the at least one second opening of the first mold element being released for outflow of the first process fluid flow out of the second mold element via the at least one second opening; therefore, the closure element of a closure device assigned to the at least one second opening of the second mold element is moved into the open position. Thus, the first process fluid flow, which has flowed into the second mold element via the at least one third opening, flows out of the second mold element, via the at least second opening of the second mold element.

In all embodiments, the first and the second process fluid flow can be provided via at least one process fluid provision device. In this case, according to the method, a process fluid provision device can be used, which device is configured to selectively provide the first mold element with a process fluid for forming the first process fluid flow, and/or to provide the second mold element with a process fluid for forming the second process fluid flow. Thus, the first mold element and the second mold element can be assigned a common process fluid provision device, via which a process fluid can be selectively provided for generating a first and/or second process fluid flow. In principle, however, it is also conceivable that a first process fluid provision device, which is assigned to the or a first mold element and via which a process fluid can be provided, for generating a first process fluid flow, and a second process fluid provision device which is assigned to the or a second mold element and via which a process fluid can be provided, for generating a second process fluid flow, may be used. In all embodiments, a corresponding process fluid provision device can comprise for example a container device which is filled with process fluid, optionally conditioned to a specific temperature and/or a specific pressure, for providing to the first and/or second mold element.

As mentioned, according to the method mold elements can be used which each comprise a flow channel structure comprising at least one flow channel. In particular, a first and a second mold element can be used, which each comprise a flow channel structure which is arranged or formed so as to extend between at least one respective first opening and at least one respective second opening, and through which the respective process fluid flow can flow or flows. In this case, the respective first openings, as also mentioned, can each be assigned at least one first valve or control valve device, and/or the respective second openings can each be assigned at least one second valve or control valve device. Thus, each mold element can comprise at least one first and/or second valve or control valve device, i.e. in general at least one closure device, which is assigned to a respective first and/or second opening and via which flow parameters, i.e. in particular the pressure, of the process fluid flow flowing into the respective mold element, and/or flow parameters, i.e. in particular the pressure, of the process fluid flow flowing out of the respective mold element, can be set, i.e. controlled or regulated.

Proceeding from mold elements configured in each case having at least one second valve or control valve device, according to the method at least one further regulatable valve or control valve device, arranged downstream of the respective second closure or control valve devices on the mold element side, can be used. Said at least one further valve or control valve device, which can also be referred to as a “third control valve device”, is assigned to the respective second valve or control valve devices on the mold element side, typically together, such that the respective second valve or control valve devices on the mold element side can be or are fluidically connected to the at least one further valve or control valve device, via a common line connection.

It is furthermore conceivable that a plurality of further regulatable valve or control valve device, arranged downstream of the respective second closure or control valve devices on the mold element side, may be used. The plurality of further valve or control valve devices are typically arranged or formed in a manner connected in parallel. The plurality of further valve or control valve device, which can also be referred to, for example, as a “third control valve device” and “fourth control valve device”, is assigned to the respective second valve or control valve devices, typically together, such that the respective second valve or control valve devices can be or are fluidically connected to the plurality of further valve or control valve devices, via a common line connection.

According to the method, the operation of the at least one further regulatable valve or control valve device can be regulated in order to set, i.e. in particular to control or regulate, the pressure or the pressure level within the first and/or second mold element, and thus the pressure or the pressure level of a process fluid flow flowing through the first and/or second mold element. In this way, an additional possibility is provided for setting the pressure or pressure level of a process fluid flow flowing through the first and/or second mold element. A corresponding regulation of the pressure or pressure level within the first and/or second mold element, or of a process fluid flow flowing through the first and/or second mold element, is possible in particular by means of a configuration of the device used according to the method, comprising a plurality of further valve or control valve devices in a parallel arrangement, wherein a further valve or control valve device, which can be referred to for example as a third valve or control valve device, can be used as a main valve or main control valve device, and a further valve or control valve device, which is arranged in parallel therewith and can be referred to for example as a fourth valve or control valve device, can be used as a control valve device for controlling or regulating the pressure or pressure level within the first and/or second mold element.

The operation of the at least one further regulatable control valve device can likewise be set, i.e. in particular controlled or regulated, in order to set the pressure or the pressure level within a respective second valve or control valve device on the mold element side. In particular, the operation of the at least one further regulatable control valve device can be set, i.e. in particular controlled or regulated, in order to set the pressure or the pressure level of a second valve or control valve device of the second mold element. The setting of the pressure or pressure level within the second mold element can be carried out in particular when the second closure or control valve device assigned to the first mold element is closed. The setting of the pressure or pressure level within the first mold element can be carried out in an analogous manner, when the second closure device assigned to the second mold element is closed.

As mentioned, the first and the second process fluid flow typically flow through the respective mold elements simultaneously. In this case, start and end timepoints of the first and second process fluid flow can coincide. In other words, according to the method the second process fluid flow is typically generated when the first process fluid flow is or was also generated. Depending on the processing process, i.e. in particular depending on parameters of the particle foam material to be processed, such as the chemical and/or physical configuration, quantity, etc thereof, and/or depending on parameters of the particle foam molding to be produced, such as the geometry, volume, etc thereof, the two process fluid flows can flow simultaneously or in parallel, in particular for a time period between 0.2 s and 60 s, more particularly for a time period between 0.2 s and 45 s, more particularly a time period between 0.2 s and 30 s, more particularly for a time period between 0.2 s and 15 s. The duration of the simultaneous or parallel generation or flow of the process fluid flows is thus typically determined depending on corresponding particle foam material-specific or particle foam molding-specific parameters.

According to the method, the mold elements, in particular for different evaporation processes, within which the first and second process fluid flow is generated in each case, can alternate or be used by turns as the first mold element and as the second mold element, and, accordingly, for example in a cycle-dependent or cycle-specific manner, a first and a second process fluid flow can flow therethrough alternately or by turns. In this way, what is referred to as “alternating evaporation” can be achieved, which, viewed over a complete processing process for producing a particle foam molding, allows, overall, a largely homogeneous flow through the particle foam material that is located inside the mold cavity and is to be processed, forming a particle foam molding, which typically has a positive effect on the properties of the particle foam molding to be produced.

A second aspect of the invention relates to a device for processing particle foam material for producing a particle foam molding. The device can also be designatable or designated as a molding machine.

The device typically comprises, as a central functional unit, a mold comprising a first mold element and a second mold element, wherein the first and the second mold element are configured, in particular by at least one movement relative to one another, to define a mold cavity.

The first mold element comprises at least one corresponding first opening, via which a process fluid flow can flow into the mold cavity via the first mold element, and at least one corresponding, in particular nozzle-like or nozzle-shaped, third opening, via which a process fluid flow can flow into the mold cavity via the first mold element, or via which a process fluid flow can flow out of the mold cavity into the first mold element. Typically, the first mold element typically also comprises at least one corresponding second opening, via which a process fluid can flow out of the first mold element, wherein it does not flow into the mold cavity.

The second mold element comprises at least one corresponding, in particular nozzle-like or nozzle-shaped, third opening, via which a process fluid flow can flow out of the mold cavity into the second mold element, or via which a process fluid flow can flow into the mold cavity via the second mold element, and at least one corresponding second opening, via which a process fluid flow can flow out of the second mold element, wherein it does not flow into the mold cavity. Typically, the second mold element typically also comprises at least one corresponding first opening, via which a process fluid can flow into the second mold element.

The device furthermore typically comprises a process fluid actuator device as a further functional unit. The process fluid actuator device is configured for controlling or regulating the operation of one or more closure devices which can be or are assigned to the respective mold elements, in particular for generating respective process fluid flows. By means of a corresponding control or regulation of the operation of respective closure devices assigned to the respective mold elements, a corresponding first process fluid flow that flows through the first mold cavity can be generated, which process fluid flow flows into the mold cavity via at least one third opening of the first mold element and flows out of the mold cavity via at least one third opening of the second mold element, and a corresponding second process fluid flow can be generated which flows through the second mold element, which process fluid flow flows into the second mold element via at least one first opening of the second mold element, and flows out of the second mold element via at least one second opening of the second mold element, wherein it does not flow into the mold cavity.

The process fluid actuator device is furthermore configured for setting at least one flow parameter that influences the flow properties of at least one process fluid flow, i.e. in particular the pressure or pressure level, by means of a corresponding control or regulation of the operation of one or more of the closure devices assigned to the respective mold elements, in particular in such a way that the first and the second process fluid flow differ with respect to at least one flow parameter that influences the flow properties.

Thus, in general, in any case from a functional perspective, the process fluid actuator device can comprise those functional units of the device which are required for setting at least one flow parameter that influences the flow properties of at least one process fluid flow, for example the pressure or pressure level of respective process fluid flows. These include in particular corresponding closure devices, i.e. in particular valve or control valve devices, which can be or are directly or indirectly assigned to respective mold elements.

Typically, as a further functional unit of the device, a computer-implemented, i.e. in particular hardware- and/or software-implemented, control and/or regulating device is assigned to the process fluid actuator device, which control and/or regulating device is in particular configured to generate control or regulation information for controlling or regulating the operation of one or more of the closure devices assigned to the respective mold elements, e.g. for setting at least one flow parameter that influences the flow properties of at least one process fluid flow, in particular such that the first and the second process fluid flow differ in at least one flow parameter that influences the flow properties, such as the pressure or pressure level. Therefore, the control and/or regulating device can be configured correspondingly for generating corresponding control or regulation information for controlling or regulating the operation of respective closure devices, i.e. in particular respective control valve devices, in particular in such a way that the first and the second process fluid flow differ in the at least one flow parameter that influences the flow properties.

All the statements in relation to the method according to the first aspect of the invention apply analogously for the device according to the second aspect of the invention, and vice versa.

The invention is explained in greater detail with reference to embodiments in the drawings, in which:

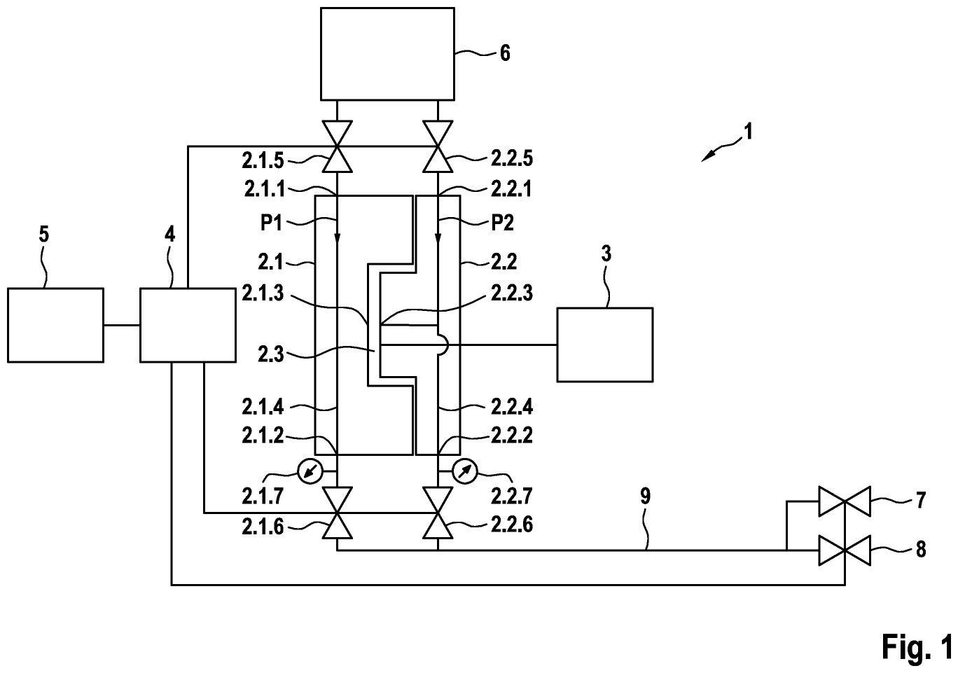

FIG. 1 is a schematic view of a device for processing particle foam material for producing a particle foam molding according to one embodiment; and

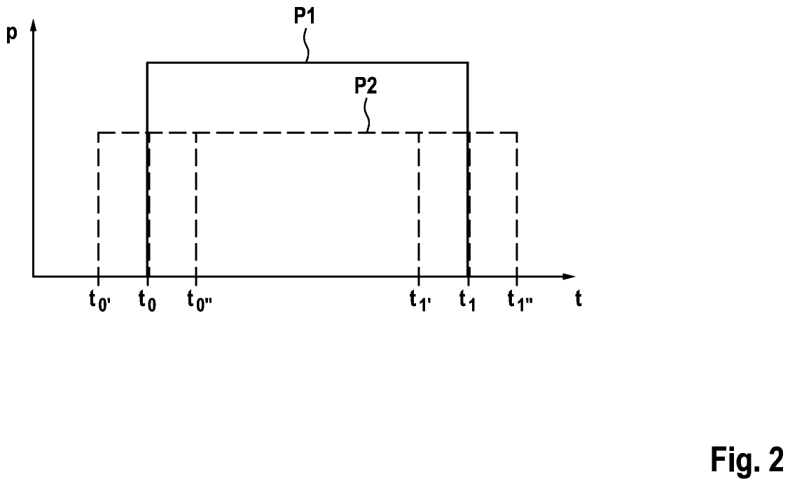

FIG. 2 is a graph for illustrating a method for processing particle foam material for producing a particle foam molding according to one embodiment.

FIG. 1 is a schematic view of a device 1 for processing particle foam material for producing a particle foam molding according to one embodiment.

The device 1, which can be or is also referred to as a molding machine, is configured for processing an expandable or expanded particle foam material, and thus for processing plastics particles composed of at least one expandable or expanded plastics particle material, for producing particle foam moldings.

The device 1 is configured accordingly for carrying out one or more work processes for processing particle foam material for producing a particle foam molding. The term “work process” in principle includes any process that can be carried out by means of the device 1, which is directly or indirectly related to the processing of a particle foam material for producing a particle foam molding. Work processes that can be carried out by means of the device 1 are in particular processing processes in which (actual) processing of a particle foam material, i.e. in particular a connection of plastics particles, forming a particle foam molding to be produced, takes place, or provision processes, in which a quantity of particle foam material, in particular a quantity of particle foam material to be processed in a processing process, is provided, or conveying processes, in which a quantity of particle foam material, in particular a quantity of particle foam material to be processed in a processing process, is conveyed along a conveying path (not shown), or filling processes, in which a quantity of particle foam material, in particular a quantity of particle foam material to be processed in a processing process, is filled into a mold cavity 2.3 of a mold 2 of the device 1.

Within the context of a processing process, a working or process fluid is used, which fluid can be an, in particular liquid, vaporous or gaseous energy carrier medium, i.e. for example a liquid, i.e. in particular water, steam, i.e. in particular superheated steam, or a gas, which absorbs or outputs energy, i.e. in particular thermal energy, kinematic energy, etc., within the context of the operation of the device.

The device 1 comprises, as a functional unit by way of example, the above-mentioned mold 2, which comprises two mold elements 2.1, 2.2, which can also be referred toa s mold halves, which are mounted so as to be movable relative to one another, via a drive device (not shown), for transferring the mold element 1 into a closed position indicated by way of example in FIG. 1, and into an open position (not shown in FIG. 1). It is clear that the mold elements 2.1, 2.2 delimit or define a mold cavity 2.3 in the closed position.

The mold cavity 2.3 can be filled, by means of a filling device 3 that forms a further functional unit of the device 1 and for example is configured as or comprises a flow generation device, with particle foam material that is to be processed by the device 1, i.e. in particular by the mold 2, for producing a particle foam molding.

The mold elements 2.1, 2.2 each comprise at least one first opening 2.1.1, 2.2.1, which can optionally also be referred to as an inflow opening and via which a process fluid or a process fluid flow P1, P2 can flow into the respective mold element 2.1, 2.2, and at least one second opening 2.1.2, 2.2.2, which can optionally also be referred to as an outflow opening and via which a process fluid or a process fluid flow P1, P2 can flow out of the respective mold element 2.1, 2.2. The mold elements 2.1, 2.2 furthermore each comprise at least one third opening 2.1.3, 2.2.3, which is formed in the manner or shape of a nozzle and via which a process fluid flow which has flowed into the respective mold element 2.1, 2.2 via the respective first opening 2.1.1, 2.2.1 can flow out of the respective mold element 2.1, 2.2 into the mold cavity 2.3. In particular in connection with respective third openings 2.1.3, 2.2.3, it is the case that the mold elements 2.1, 2.2 can each comprise a plurality of corresponding third openings 2.1.3, 2.2.3. Corresponding third openings 2.1.3, 2.2.3 are arranged or formed in particular in the region of respective shaping mold element portions of the respective mold elements 2.1, 2.2.

The respective first, second and third openings 2.1.1-2.1.3, 2.2.1-2.2.3 of a respective mold element 2.1, 2.2 are typically fluidically interconnected via a flow channel structure 2.1.4, 2.2.4 that comprises at least one flow channel (not labelled) that passes through the respective mold element 2.1, 2.2, at least in portions, such that a process fluid flow P1, P2 that has flowed into the respective mold element 2.1, 2.2 via a respective first opening 2.1.1, 2.2.1 can flow out of the respective mold element 2.1, 2.2 via a respective second opening 2.1.2, 2.2.2 and/or via a respective third opening 2.1.3, 2.2.3. A corresponding flow channel structure 2.1.4, 2.2.4 can in each case extend at least in portions close to the contour, i.e. closely under respective shaping mold element portions of respective mold elements 2.1, 2.2, for example in order to enable an energy transfer from the respective mold element portion to the or a particle foam material filled into the mold cavity 2.3, when a process fluid flow P1, P2 flows through.

It is clear in the embodiment shown in FIG. 1 that respective first and second openings 2.1.1, 2.1.2, 2.2.1, 2.2.2 on the mold element side are each assigned at least one closure device 2.1.5, 2.1.6, 2.2.5, 2.2.6, which comprises at least one closure element (not shown) that is movable between a first position, which can also be referred to as the open position and in which a process fluid flow P1, P2 can flow through the respective closure device 2.1.5, 2.1.6, 2.2.5, 2.2.6, and a second position, which can also be referred to as the closed position and in which a process fluid flow P1, P2 cannot flow through the respective closure device 2.1.5, 2.1.6, 2.2.5, 2.2.6. A corresponding closure element can typically also be moved into at least one intermediate position located between a corresponding first and second position. Corresponding closure devices 2.1.5, 2.1.6, 2.2.5, 2.2.6 can in particular be configured as or comprise active or passive flow limiters. Corresponding active or passive flow limiters can be configured for example as valve devices, in particular as controllable or regulatable control valve devices. In the embodiment shown in FIG. 1, the closure devices 2.1.5, 2.1.6, 2.2.5, 2.2.6 are formed, by way of example, as controllable or regulatable control valve devices.

The device 1 furthermore comprises a process fluid actuator device 4 as a further functional unit. The process fluid actuator device 4 is configured for controlling or regulating the operation of one or more closure devices 2.1.5, 2.1.6, 2.2.5, 2.2.6, 7, 8 which can be or are assigned to the respective mold elements 2.1, 2.2, in particular for generating respective process fluid flows P1, P2. By means of a corresponding control or regulation of the operation of respective closure devices 2.1.5, 2.1.6, 2.2.5, 2.2.6, 7, 8, a corresponding first process fluid flow P1 can be generated, which process fluid flow flows into the mold cavity 2.3 via a third opening 2.1.3 of the or a first mold element 2.1 and flows out of the mold cavity 2.3 via at least one third opening 2.2.3 of the or a second mold element 2.2, and a corresponding second process fluid flow P2 can be generated, which process fluid flow flows into the second mold element 2.2 via the or a first opening 2.2.1 of the second mold element 2.2, and flows out of the second mold element 2.2 via the or a second opening 2.2.2 of the second mold element 2.2, wherein it does not flow into the mold cavity 2.3.

As emerges in the following, both mold elements 2.1, 2.2 can be operated interchangeably or alternately, for example in a cycle-dependent or cycle-specific manner, as the first or second mold element.

The process fluid actuator device 4 is furthermore configured for setting at least one flow parameter that influences the flow properties of at least one process fluid flow P1, P2, i.e. in particular the pressure or pressure level of a process fluid flow P1, P2, by means of a corresponding control or regulation of the operation of corresponding closure devices 2.1.5, 2.1.6, 2.2.5, 2.2.6, 7, 8, in particular in such a way that the first and the second process fluid flow P1, P2 differ with respect to at least one flow parameter that influences the flow properties, i.e. in particular a pressure or pressure level.

Thus, in general, in any case from a functional perspective, the process fluid actuator device 4 comprises those functional units of the device 1 which are required for setting at least one flow parameter that influences the flow properties of at least one process fluid flow P1, P2, i.e. in particular the pressure or pressure level of respective process fluid flows P1, P2. These include in particular corresponding closure devices 2.1.5, 2.1.6, 2.2.5, 2.2.6, 7, 8 which are directly or indirectly assigned to respective mold elements 2.1, 2.2.

As a further functional unit of the device 1, a computer-implemented, i.e. in particular hardware- and/or software-implemented, control and/or regulating device 5 is assigned to the process fluid actuator device 4, which control and/or regulating device is configured to generate control or regulation information for setting at least one flow parameter that influences the flow properties of at least one process fluid flow P1, P2, i.e. in particular the pressure or pressure level, in particular in such a way that the first and the second process fluid flow P1, P2 differ in the at least one flow parameter that influences the flow properties. For this purpose, the control and/or regulating device 5 can be configured for generating corresponding control or regulation information for controlling or regulating the operation of respective closure devices 2.1.5, 2.1.6, 2.2.5, 2.2.6, in particular in such a way that the first and the second process fluid flow P1, P2 differ in the at least one flow parameter that influences the flow properties.

The device 1 furthermore comprises, as a further functional unit, a process fluid provision device 6, which is configured to selectively provide the first mold element 2.1 with a process fluid for forming the first process fluid flow P1, and/or to provide the second mold element 2.2 with a process fluid for forming the second process fluid flow P2. The process fluid provision device 6 can comprise for example a container device which is filled with process fluid, optionally conditioned to a specific temperature and/or a specific pressure, for providing to the first and/or second mold element 2.1, 2.2.

A method for processing particle foam material for producing a particle foam molding can be implemented by means of the configuration of the device 1 shown by way of example in FIG. 1. An embodiment of a corresponding method is explained by way of example below, with reference to FIGS. 1 and 2:

The method includes a first step of generating a first process fluid flow P1, i.e. for example a flow of steam or superheated steam, which flows through the or a corresponding mold cavity 2.3. The first process fluid flow P1 flows into the mold cavity 2.3 via the nozzle-like or nozzle-shaped third opening 2.1.3 of the first mold element 2.1, and flows out of the mold cavity 2.3 via the nozzle-like or nozzle-shaped third opening 2.2.3 of the second mold element 2.2. Therefore, in the first step of the method, what is known as cross evaporation of the in this case typically virtually or completely closed mold cavity 2.3 typically takes place, i.e. the first process fluid flow P1 flows into the first mold element 2.1 via respective first openings 2.2.1 of the first mold element 2.1, flows out of the first mold element 2.1 and into the mold cavity 2.3 via the respective third opening 2.1.3 of the first mold element 2.1, flows through the mold cavity 2.3 in the direction of the second mold element 2.2, wherein bonding of the particle foam material located in the mold cavity 2.3, forming the particle foam molding to be produced, takes place, flows into the second mold element 2.2 via respective third openings 2.2.3 of the second mold element 2.2, and flows out of the second mold element 2.2 via respective second openings 2.2.2 of the second mold element 2.2.

Similarly, the method includes a second step of generating a second process fluid flow P2, i.e. for example a flow of steam or superheated steam. The second process fluid flow P2 flows into the second mold element 2.2 via respective first openings 2.2.1 of the second mold element 2.2, and flows out of the second mold element 2.2 via respective second openings 2.2.2 of the second mold element 2.2. Therefore, in the second step of the method, in parallel with the cross evaporation taking place in the first step of the method, a second process fluid flow P2 that flows through the second mold element 2.2 between respective first and second openings 2.2.1, 2.2.2 is generated, such that during the cross evaporation additional energy can be introduced into the second mold element 2.2, in a purposeful manner, via the second process fluid flow P2. The second step of the method is not a second cross evaporation of the mold cavity 2.3 proceeding from the second mold element 2.2, as the second process fluid flow P2 flows through the second mold element 2.2 only between respective first and second openings 2.2.1, 2.2.2 of the second mold element 2.2, but does not flow out into the mold cavity 2.3 via corresponding nozzle-like or nozzle-shaped third openings 2.2.3 of the second mold element 2.2.

As is clear from FIG. 2, according to the method the first and the second step are typically carried out simultaneously. The designation “first step” and “second step” therefore does not indicate that the steps are carried out in a temporally successive manner, but rather that these are respective steps of generating corresponding first and second process fluid flows P1, P2.

According to the method, the first and the second process fluid flow P1, P2 differ in at least one flow parameter that influences the flow properties, i.e. in particular the pressure or pressure level. The setting, i.e. in particular control or regulation, of respective flow parameters that influence the flow properties of the first and second process fluid flow P1, P2, which is possible, in a purposeful manner, according to the method, via the or a control and/or regulating device 5, is thus carried out with the proviso that the first and the second process fluid flow P1, P2 differ with respect to at least one flow parameter that influences the flow properties. This purposeful adjustment of the flow parameters or properties of the process fluid flows P1, P2 to one another makes it possible to ensure that the first and second process fluid flows P1, P2 do not compromise one another. Said purposeful adjustment of the flow parameters or properties of the process fluid flows P1, P2 to one another in particular makes it possible to ensure that the second process fluid flow P2 does not negatively influence the first process fluid flow P1, flowing through the mold cavity 2.3, and thus the bonding of the particle foam material, occurring or brought about by means of the first process fluid flow P1, for producing a respective particle foam molding.

The method is thus based on the principle of the generation of a corresponding second process fluid flow P2, which takes place additionally to the generation of a corresponding first process fluid flow P1, which has a very positive effect on the efficiency of the processing process and thus on the efficiency of the method as a whole, as the thermal energy additionally supplied to the second mold element 2.2 by the second process fluid flow P2 increases the efficiency of the energy input or the introduction of energy within the context of the bonding process of respective particle foam materials to form particle foam moldings, and, associated therewith, allows for a cycle times to be reduced.

As mentioned, the flow parameter influencing the flow properties is in particular the pressure or the pressure level of the first and second process fluid flow P1, P2. Therefore, the control or regulation, in particular of the pressure or pressure level of the first and second process fluid flow P1, P2, which is possible, in a purposeful manner, according to the method, via the control and/or regulating device 5, is thus carried out with the proviso that the first and the second process fluid flow P1, P2 differ with respect to their respective pressure or pressure level. The acquisition of the pressure or pressure level of the respective process fluid flows P1, P2 can be carried out by means of pressure acquisition devices 2.1.7, 2.2.7, such as pressure sensors. Corresponding pressure acquisition devices 2.1.7, 2.2.7 can be arranged or formed on or in respective mold elements 2.1, 2.2. In particular, corresponding pressure acquisition devices 2.1.7, 2.2.7 can, as shown by way of example in FIG. 1, be arranged or formed on or in the region of respective second openings 2.1.2, 2.2.2 of the mold elements 2.1, 2.2. The pressure or pressure level of respective process fluid flows P1, P2 can thus relate, for example, to the pressure or the pressure level during outflow of the respective process fluid flows P1, P2 out of the respective mold elements 2.1, 2.2.

According to the method, the second process fluid flow P2 typically has a lower pressure than the first process fluid flow P1. In this way, it is possible to ensure that the second process fluid flow P2 does not impair the first process fluid flow P1, for example in that the second process fluid flow P2 impedes, on account of too high a pressure, an outflow of the first process fluid flow P1 out of the mold cavity 2.3 via the third opening 2.2.3 of the second mold element 2.2, or an inflow of the first process fluid flow P1 into the second mold element 2.2 via the third opening 2.2.3 of the second mold element 2.2. The pressure or the pressure level of the second process fluid flow P2 can be selected, in particular relative to the pressure or pressure level of the first process fluid flow P1, in particular after this has flowed through the mold cavity 2.3, in such a way that a certain suction effect is generated by the second process fluid flow P2, which promotes the flow of the first process fluid flow P1 through the mold cavity 2.3.

The second process fluid flow P2 expediently has a pressure that is lower than that of the first process fluid flow P1 by a factor of 2. However, this is to be understood as being purely by way of example. The pressure or the pressure level of the second process fluid flow P2 can be for example 0.95 times, 0.9 times, 0.85 times, 0.8 times, 0.75 times, 0.7 times, 0.65 times, 0.6 times, 0.55 times, 0.5 times, 0.45 times, 0.4 times, 0.35 times, 0.3 times, 0.25 times, 0.2 times, 0.15 times, 0.1 times, or 0.05 times the pressure or pressure level of the first process fluid flow P1.

The corresponding pressure differences between the first and the second process fluid flow P1, P2 can, according to the method, optionally be adjusted or set, i.e. in particular controlled or regulated, dynamically, in a positive or negative manner, i.e. upwards and/or downwards. In principle, the implementation of different, optionally variable, pressure difference profiles is thus conceivable, which profiles are typically selected depending on properties of the particle foam material to be processed, such as the chemical and/or physical composition of the particle foam material, and/or of properties of the configuration of the mold, such as the size of the mold cavity, etc.

The generation, carried out according to the method, of a corresponding first process fluid flow P1 thus includes, for a device 1 configured as in FIG. 1, with respect to the respective first mold element 2.1, the first opening 2.1.1 of the first mold element 2.1 being released for inflow of the first process fluid flow P1 into the first mold element 2.1 via the first opening 2.1.1; therefore, the closure element of the closure device 2.1.5 assigned to the first opening 2.1.1 of the first mold element 2.1 is moved into the or an open position, in which a flow through the closure device 2.1.5 is possible. In the same way, the second opening 2.1.2 of the first mold element 2.1 is not released for outflow of the first process fluid flow P1 out of the first mold element 2.1 via the second opening 2.1.2; therefore, the closure element of the closure device 2.1.6 assigned to the second opening 2.1.2 of the first mold element 2.1 is moved into the or a closed position. Thus, the first process fluid flow P1, which has flowed into the first mold element 2.1 via the first opening 2.1.1, flows out of the first mold element 2.1, via the third opening 2.1.3 of the first mold element 2.1, into the mold cavity 2.3 that is filled with particle foam material. After the first process fluid flow P1 has flowed through the mold cavity 2.3 filled with particle foam material, the first process fluid flow P1 flows into the second mold element 2.2 via the third opening 2.2.3 of the second mold element 2.2, and flows out of the second mold element 2.2 via the second opening 2.2.2 of the second mold element 2.2.

The generation, carried out according to the method, of a first process fluid flow P1 that flows through the mold cavity 2.3 thus includes, for a device 1 configured as in FIG. 1, with respect to the respective second mold element 2.2, the second opening 2.2.2 of the second mold element 2.2 being released for outflow of the first process fluid flow P1 out of the second mold element 2.2 via the second opening 2.2.2; therefore, the closure element of the closure device 2.2.6 assigned to the second opening 2.2.2 of the second mold element 2.2 is moved into the open position. The first process fluid flow P1 that has flowed into the second mold element 2.2 via the third opening 2.2.3 of the second mold element 2.2 thus flows out of the second mold element 2.2 via the second opening 2.2.2 of the second mold element 2.2.

The above statements of course apply analogously for configurations of respective mold elements 2.1, 2.2 comprising a plurality of first and/or second and/or third openings 2.1.1-2.1.3, 2.2.1-2.2.3.

Within the context of carrying out the method, the mentioned process fluid provision device 6 can selectively provide the first mold element 2.1 with a process fluid for forming the first process fluid flow P1, and/or provide the second mold element 2.2 with a process fluid for forming the second process fluid flow P2.

Proceeding from the configuration shown in FIG. 1 of the mold elements configured having at least one closure device 2.1.6, 2.2.6, i.e. as mentioned, for example a valve or control valve device, according to the method a plurality of further regulatable closure devices 7, 8, arranged downstream of the respective second closure devices 2.1.6, 2.2.6 on the mold element side, can be used. Said further closure devices 7, 8, which are arranged in parallel and can also be referred to as a “third control valve device” and “fourth control valve device”, respectively, are assigned to the respective second closure devices 2.1.6, 2.2.6 on the mold element side together, such that the respective second closure devices 2.1.6, 2.2.6 on the mold element side can be or are fluidically connected to the further closure devices 7, 8 via a common line connection 9.

According to the method, the operation of one of the further closure devices 7, 8, which can furthermore likewise be regulatable valve or control valve devices, can be regulated in order to set, i.e. in particular to control or regulate, the pressure or the pressure level within the second mold element 2.2, and thus the pressure or the pressure level of a process fluid flow P1, P2 flowing through the second mold element 2.2. In this way, an additional possibility is provided for setting the pressure or pressure level of a process fluid flow P1, P2 flowing through the second mold element 2.2. A corresponding regulation of the pressure or pressure level within the second mold element 2.2, or of a process fluid flow P1, P2 flowing through the second mold element 2.2, is possible in particular by means of a configuration, shown in FIG. 1, of the device 1, wherein a further closure device, which can be referred to for example as a third closure device 7, can be used as a main valve or main control valve device, and a further closure device 8, which is arranged in parallel therewith and can be referred to as a fourth closure device, can be used as a control valve device for controlling or regulating the pressure or pressure level within the first and/or second mold element 2.1, 2.2.

The operation of the third and/or fourth closure device 7, 8 can likewise be set, i.e. in particular controlled or regulated, in order to set the pressure or the pressure level within a respective second valve or control valve device 2.1.6, 2.2.6 on the mold element side. In particular, the operation of the third and/or fourth closure device 7, 8 can be set, i.e. in particular controlled or regulated, in order to set the pressure or the pressure level of a second closure device 2.2.6 of the second mold element 2.2. The setting of the pressure or pressure level within the second mold element 2.2 can be carried out in particular when the second closure device 2.1.6 assigned to the first mold element 2.1 is closed. The setting of the pressure or pressure level within the first mold element 2.1 can be carried out in an analogous manner, when the second closure device 2.2.6 assigned to the second mold element 2.2 is closed.

According to the method, the mold elements, in particular for different evaporation processes, within which the first and second process fluid flow is generated in each case, can be used alternately as the first mold element and as the second mold element, and, accordingly, alternately a first and a second process fluid flow can flow therethrough. In this way, what is referred to as “alternating evaporation” can be achieved, which, viewed over a complete processing process for producing a particle foam molding, allows, overall, a largely homogeneous flow through the particle foam material that is located inside the mold cavity and is to be processed, forming a particle foam molding, which typically has a positive effect on the properties of the particle foam molding to be produced.

With reference to FIG. 2, various variants of the method are explained again: As mentioned, the first and the second process fluid flow typically flow through the respective mold elements 2.1, 2.2 simultaneously. In this case, as shown in FIG. 2 by the solid line, start and end timepoints of the first and second process fluid flow can coincide. In other words, according to the method the second process fluid flow P2 is typically generated when the first process fluid flow P1 is or was also generated.

As is shown in FIG. 2, which shows a graph of a temporal pressure curve of first and second process fluid flows P1, P2, wherein the pressure p is plotted on the y-axis and the time t on the x-axis, likewise shown by the dot-dashed lines, the start and/or end timepoint of the second process fluid flow P2 can, however, also be temporally shifted with respect to the start timepoint to and/or the end timepoint t₁ of the first process fluid flow P1. A start timepoint of the second process fluid flow P2 that is shifted forward in time is indicated in FIG. 2 at the timepoint t₀′, and a start timepoint of the second process fluid flow P2 that is shifted back in time is indicated in FIG. 2 at the timepoint t₀″. An end timepoint of the second process fluid flow P2 that is shifted forward in time is indicated in FIG. 2 at the timepoint t₁′, and a start timepoint of the second process fluid flow P2 that is shifted back in time is indicated in FIG. 2 at the timepoint t₁″.

It is clear from FIG. 2 that, depending on the processing process, i.e. in particular depending on parameters of the particle foam material to be processed, such as the chemical and/or physical configuration, quantity, etc thereof, and/or depending on parameters of the particle foam molding to be produced, such as the geometry, volume, etc thereof, the two process fluid flows P1, P2 flow simultaneously or in parallel for a certain time period, e.g. a time period between 0.2 s and 60 s. The duration of the simultaneous or parallel generation or flow of the process fluid flows P1, P2 is thus typically determined depending on corresponding particle foam material-specific or particle foam molding-specific parameters.

1. Method for processing particle foam material for producing a particle foam molding, the method comprising:
generating a first process fluid flow which flows through a mold cavity defined by two mold elements, wherein the first process fluid flow flows into the mold cavity via at least one opening of a first mold element and flows out of the mold cavity via at least one opening of a second mold element; and
generating a second process fluid flow, wherein the second process fluid flow flows into the second mold element via at least one opening of the second mold element and flows out of the second mold element via at least one opening of the second mold element, wherein
the first and the second process fluid flow differ in at least one flow parameter that influences the flow properties.

2. Method according to claim 1, wherein the at least one flow parameter that influences the flow properties is the pressure of the process fluid flows.

3. Method according to claim 1, wherein the second process fluid flow has a lower pressure than the first process fluid flow, in particular lower at least by a factor of 2.

4. Method according to claim 1, wherein the first and the second process fluid flow are provided by at least one process fluid provision device, wherein a process fluid provision device is used which is configured to selectively provide the first mold element with a process fluid for forming the first process fluid flow, and/or to provide the second mold element with a process fluid for forming the second process fluid flow.

5. Method according to claim 1, wherein a first mold element is used, which has a flow channel structure that is arranged of formed so as to extend between at least one inflow opening and at least one outflow opening and through which a process fluid flow can flow or flows, wherein the at least one inflow opening is assigned at least one first closure device, and the at least one outflow opening is assigned at least one second closure device, and
a second mold element is used, which has a flow channel structure that is arranged of formed so as to extend between at least one inflow opening and at least one outflow opening and through which a process fluid flow can flow or flows, wherein the at least one inflow opening is assigned at least one first closure device, and the at least one outflow opening is assigned at least one second closure device.

6. Method according to claim 5, wherein at least one further closure device, in particular regulatable valve device, arranged downstream of the respective second closure devices, in particular valve devices, is used.

7. Method according to claim 1, characterized in that wherein a plurality of regulatable closure devices, in particular valve devices, arranged downstream of the respective second closure devices, in particular valve devices, is used, wherein the plurality of closure devices is arranged or formed so as to be connected in parallel.

8. Method according to claim 6, wherein the operation of at least one further closure device is regulated, in order to regulate the pressure level within the first and/or second mold element.

9. Method according to claim 8, wherein the operation of the at least one further closure device is regulated, in order to regulate the pressure level within the second closure device of the second mold element, wherein the regulation of the pressure level within the second mold element takes place when the second closure device assigned to the first mold element is closed.

10. Method according to claim 1, characterized in that wherein the first and the second process fluid flow flow simultaneously through the mold cavity, in particular for a time period between 0.2 s and 60 s.

11. Method according to claim 1, wherein steam, in particular superheated steam, is used as the process fluid forming the respective process fluid flow.

12. Method according to claim 1, wherein the mold elements are used alternately as the first mold element and as the second mold element, in particular for different evaporation processes of the mold cavity, within which in each case a corresponding first and a corresponding second process fluid flow is produced.

13. Device for processing particle foam material for producing a particle foam molding, the device comprising:
a first mold element and a second mold element, wherein the first and the second mold element are configured, in particular by at least one movement relative to one another, to define a mold cavity, wherein
the first mold element comprises at least one opening, via which a process fluid flow can flow into the mold cavity via the first mold element, and
the second mold element comprises at least one opening via which a process fluid flow can flow out of the mold cavity and into the second mold element, and comprises at least one opening via which a process fluid flow can flow out of the second mold element;
a process fluid actuator device, which is configured for controlling or regulating the operation of one or more closure devices which can be or are assigned to the respective mold elements,
is configured for generating a first process fluid flow which flows through the mold cavity, wherein the first process fluid flow flows into the mold cavity via at least one opening of the first mold element, and flows out of the mold cavity via at least one opening of the second mold element; and
is configured for generating a second process fluid flow that flows through the second mold element, wherein the second process fluid flow flows into the second mold element via at least one opening of the second mold element and flows out of the second mold element via at least one opening of the second mold element, and
is configured for setting at least one flow parameter that influences the flow properties of at least one process fluid flow, in particular in such a way that the first and the second process fluid flow differ in at least one flow parameter that influences the flow properties.

14. Device according to claim 13, wherein the device is configured for carrying out a method according to claim 1.
